(19) United States
(12) Patent Application Publication
(10) Pub. No.: US 2024/0374080 A1
(43) Pub. Date: Nov. 14, 2024

(54) PORTABLE OUTDOOR AIR FRYER DEVICE, SYSTEM AND METHOD THEREOF

(71) Applicant: North Atlantic Imports, LLC, Logan, UT (US)

(72) Inventors: Karrie P. Kunz, Logan, UT (US); Ryan D. Tirrell, North Logan, UT (US); Alexander J. Christensen, Logan, UT (US)

(21) Appl. No.: 18/653,948

(22) Filed: May 2, 2024

Related U.S. Application Data
(60) Provisional application No. 63/463,358, filed on May 2, 2023.

(51) Int. Cl. A47J 37/06

(52) U.S. Cl. CPC A47J 37/0641

(57) ABSTRACT

A portable outdoor air fryer that includes a main body, a basket container, and a primary fan. The main body includes a chamber wall, an inner shield, and an outer shield. The chamber wall extends to define a cooking chamber, the inner shield extends along the chamber wall to define a first gap therebetween, and the outer shield extends along the inner shield to define a second gap therebetween. The main body also includes a heating element positioned below the cooking chamber and configured to provide heat within the first gap for heating the inner shield to heat the cooking chamber. The basket container includes a container wall configured to be positioned over a chamber opening defined in the main body. The primary fan is positioned directly adjacent the cooking chamber so that the fan is configured to directly blow and mix air within the cooking chamber.

### CROSS-REFERENCE TO RELATED APPLICATIONS

This application claims the benefit of U.S. Provisional Application No. 63/463,358, filed May 2, 2023, the disclosure of which is hereby incorporated by reference herein in its entirety.

### TECHNICAL FIELD

The present invention relates generally to outdoor cooking systems and, more specifically, the present invention relates to portable outdoor air fryer devices.

### BACKGROUND

Outdoor cooking has become a favorite pass time for many as it can be utilized in multiple settings such as backyards, parks, camping, and tailgating. As outdoor cooking has increased in popularity, outdoor cooking technology has continued to adapt and improve. Some of these improvements involve bringing indoor cooking appliances to an outdoor setting so a larger variety of food may be cooked in the outdoor setting. For example, air frying technology implemented for the outdoors is disclosed in U.S. Pat. Nos. 10,638,882, 10,881,246 and 11,058,256, the disclosures of which are hereby incorporated herein in their entirety. While the concepts disclosed in these patent references provide beneficial means for air frying in the outdoors, there remains a need for better portability to minimize the size, material and weight needed to implement these air frying concepts.

### BRIEF SUMMARY OF THE INVENTION

The present invention is directed to a portable outdoor air fryer. The portable outdoor air fryer includes a main body, a basket container, and a primary fan. The main body includes a first wall, a second wall, and a third wall. The first wall extending to define a cooking chamber, the second wall extending along the first wall to define a first gap therebetween. The third wall extends along the second wall to define a second gap therebetween. The first gap and the second gap are sized and configured to provide air flow into and out of the main body. The main body includes a heating element positioned below the cooking chamber and configured to provide heat within the first gap for heating the first wall to heat the cooking chamber. The basket container includes a container wall and a handle. The basket container is positionable within the cooking chamber and removable from the cooking chamber such that, upon the basket container being positioned within the cooking chamber, the container wall is configured to be positioned over a chamber opening defined in the main body. The primary fan is positioned directly adjacent the cooking chamber so that the fan is configured to directly blow and mix air within the cooking chamber.

In another embodiment, the second wall and third wall extend to define vents positioned adjacent to each other, the vents sized and configured to direct air from the first gap and second gap to an exterior of the main body. In another embodiment, the main body extends to define an upper chamber with an upper fan positioned at least partially within the upper chamber, the upper chamber positioned above the cooking chamber such that the primary fan is positioned at least partially within the upper chamber, the upper fan configured to blow air over a motor of the primary fan. In yet another embodiment, the second gap is configured to cool an exterior of the main body such that the second gap draws air from a lower side of the main body and exits the main body along an upper portion of the main body. In another embodiment, the heating element is positioned below burner vents defined in the first wall, the burner vents sized and configured to facilitate heat into the first gap to heat the cooking chamber. In another embodiment, the primary fan is positioned at least partially within the cooking chamber to directly mix air within the cooking chamber.

In another embodiment, the primary fan is enclosed inside a fan housing, the fan housing positioned over a hole defined in the first wall extending to define the cooking chamber. In still another embodiment, the heating element comprises a gas burner, the gas burner coupled to a gas control valve having a solenoid portion and a stepper portion.

In accordance with another embodiment of the present invention, a portable outdoor air fryer is provided. The portable outdoor air fryer includes a main body, a basket container, and a primary fan. The main body extends to define chamber walls, an inner shield, and an outer shield. The chamber walls extend to define a cooking chamber. The inner shield extends along the chamber walls to define a first gap. The outer shield extends along the inner shield to define a second gap. The first gap and the second gap are sized and configured to provide air flow into and out of an interior of the main body. The second gap includes a heating element positioned adjacent to or within the second gap. The basket container includes a container wall and a handle. The basket container configured to be positioned within the cooking chamber and removable from the cooking chamber such that, upon the basket container being positioned within the cooking chamber, the container wall is configured to be positioned over a chamber opening defined in the main body. The primary fan is positioned directly adjacent the cooking chamber so that the fan is configured to mix air within the cooking chamber.

In another embodiment, the inner shield and outer shield extend to define vents therein and positioned adjacent to each other along an upper portion of the main body, the vents sized and configured to direct air from the first gap and second gap to an exterior of the main body. In another embodiment, the main body extends to define an upper chamber with a second fan positioned at least partially within the upper chamber, the upper chamber positioned above the cooking chamber such that the primary fan is positioned at least partially within the upper chamber, the second fan configured to blow air over a motor of the primary fan. In another embodiment, the second gap is configured to cool an exterior of the main body such that the second gap draws air from a lower side of the main body and exits the main body along an upper portion of the main body. In yet another embodiment, the heating element is positioned below burner vents defined in the inner shield, the burner vents sized and configured to direct heat into the first gap to heat the cooking chamber. In another embodiment, the primary fan is positioned directly adjacent the cooking chamber to directly mix air within the cooking chamber.

In another embodiment, the primary fan is enclosed inside a fan housing, the fan housing positioned over a hole defined in the first wall extending to define the cooking chamber. In still another embodiment, the heating element comprises a gas burner, the gas burner coupled to a gas control valve having a solenoid portion and a stepper portion.

In accordance with another embodiment of the present invention, a method for cooking food in a portable outdoor air fryer is provided. The method steps include: providing a main body including a first wall, a second wall, and a third wall, the first wall extending to define a cooking chamber, the second wall extending along the first wall to define a first gap therebetween, the third wall extending along the second wall to define a second gap therebetween, the first gap and the second gap sized and configured to provide air flow into and out of the main body, the main body including a heating element positioned below the cooking chamber to heat the cooking chamber; positioning a basket container containing a food product into the cooking chamber, the basket container including a container wall and a handle, the basket container being positionable and removable within the cooking chamber such that, upon the basket container being positioned within the cooking chamber, the container wall closes-off a chamber opening defined in the main body; and heating the cooking chamber by activating the heating element to produce heat within the cooking chamber; and mixing heated air within the cooking chamber with a fan positioned directly adjacent the cooking chamber.

In another embodiment, the heating step includes the step of positioning heating element in the second gap so that heat flows through burner vents positioned in the second wall so that heat flows therethrough to heat the first wall and to heat the cooking chamber. In another embodiment, the heating step includes positioning the heating element below the cooking chamber to heat the first wall and to heat the cooking chamber.

In another embodiment, the heating step includes the step of flowing heated air in the first gap to heat the first wall to heat the cooking chamber such that the heated air flows upward along the first gap and through inner vents extending from the first gap to the second gap and then through outer vents extending from the second gap to an exterior of the main body. In another embodiment, the method further includes the step of drawing air from an exterior lower side of the main body into the second gap so that air flows upward along the second gap to the outer vents to flow to the exterior of the main body.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of an air fryer, depicting a food basket in an engaged position with the air fryer, according to an embodiment of the present invention;

FIG. 2 is a perspective view of the air fryer, depicting the food basket in a disengaged position, according to another embodiment of the present invention;

FIG. 3 is a top view of the air fryer, according to another embodiment of the present invention;

FIG. 4 is a bottom view of the air fryer, according to another embodiment of the present invention;

FIG. 5 is a front view of the air fryer, according to another embodiment of the present invention;

FIG. 6 is a side view of the air fryer, according to another embodiment of the present invention;

FIG. 7 is a cross sectional view taken along section line A-A of FIG. 6, according to another embodiment of the present invention;

FIG. 8 is a cross sectional view taken along section line B-B of FIG. 5, according to another embodiment of the present invention;

FIG. 9 is a cross sectional view taken along section line C-C of FIG. 5, according to another embodiment of the present invention;

FIG. 10 is a cross sectional view taken along section line D-D of FIG. 5, according to another embodiment of the present invention;

FIG. 11 is a perspective view of the food basket, according to another embodiment of the present invention;

FIG. 12 is a side view of the food basket, according to another embodiment of the present invention;

FIG. 13 is a perspective view of another embodiment of an air fryer, according to the present invention;

FIG. 14 is a perspective view of the air fryer of FIG. 13, depicting a fryer basket in a disengaged position, according to another embodiment of the present invention;

FIG. 15 is a top view of the air fryer of FIG. 13, according to another embodiment of the present invention;

FIG. 16 is a bottom view of the air fryer of FIG. 13, depicting a battery box along a bottom side of the air fryer, according to another embodiment of the present invention;

FIG. 17 is a front view of the air fryer of FIG. 13, according to another embodiment of the present invention;

FIG. 18 is a side view of the air fryer of FIG. 13, depicting a regulator assembly coupled to the air fryer, according to another embodiment of the present invention;

FIG. 19 is a cross-sectional view of the air fryer taken along section line A-A of FIG. 18, according to another embodiment of the present invention;

FIG. 20 is a cross-sectional view of the air fryer taken along section line B-B of FIG. 17, according to another embodiment of the present invention;

FIG. 21 is a cross-sectional view of the air fryer taken along section line C-C of FIG. 17, according to another embodiment of the present invention;

FIG. 22 is a cross-sectional view of the air fryer taken along section line D-D of FIG. 17, depicting a lower side of the air fryer with some of the gas flow valving components, sensor and ignitor removed, according to another embodiment of the present invention;

FIG. 23 is a perspective view of the fryer basket, according to another embodiment of the present invention;

FIG. 24 is a side view of the fryer basket, according to another embodiment of the present invention;

FIG. 25 is a perspective view of another embodiment of an air fryer, according to the present invention;

FIG. 26 is a perspective view of the air fryer of FIG. 25, depicting a fryer basket disengaged from the air fryer, according to another embodiment of the present invention;

FIG. 27 is a perspective view of the air fryer of FIG. 25, depicting a right side wall removed to expose a gas control valve, according to another embodiment of the present invention;

FIG. 28 is a perspective view of the gas control valve, according to another embodiment of the present invention;

FIG. 29 is a cross-sectional view of the air fryer taken along section line A-A of FIG. 25, according to another embodiment of the present invention;

FIG. 30 is a front perspective view of the air fryer, depicting the fryer basket removed to expose a heat sensor, according to another embodiment of the present invention; and

FIG. 31 is a schematic view of the air fryer of FIG. 25, according to another embodiment of the present invention.

### DETAILED DESCRIPTION OF THE INVENTION

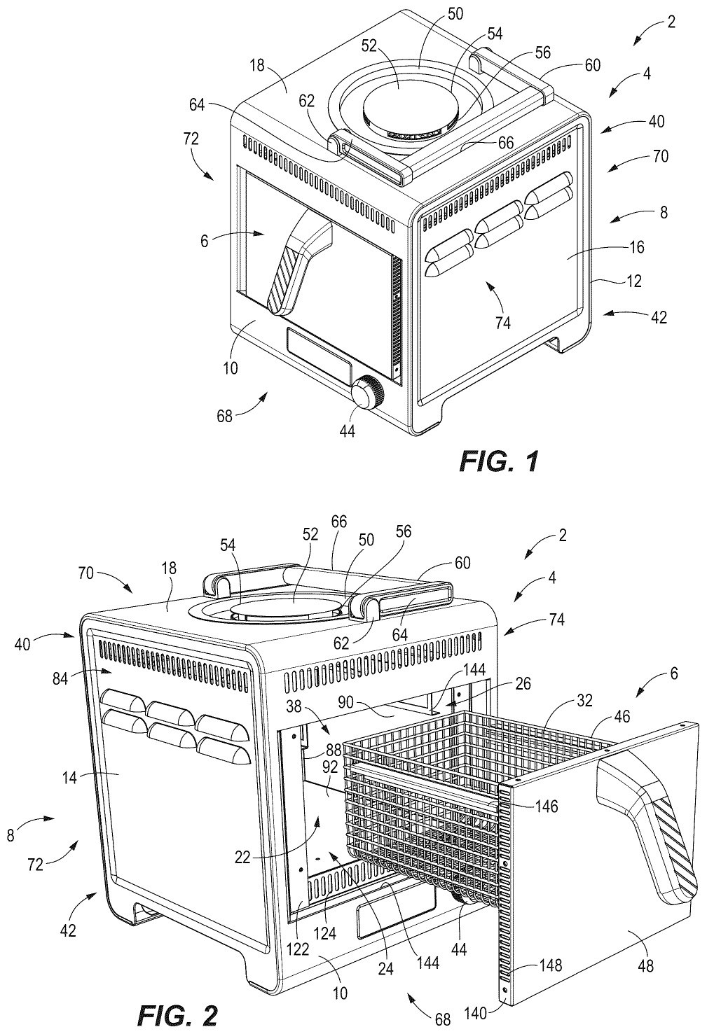

Referring to FIGS. 1, 2 and 7, an air fryer 2 sized and configured to be used in the outdoors is provided. The air fryer 2 may be relatively light weight and with a minimal size. The air fryer 2 may include a handle 60 such that the air fryer 2 can readily be carried by a single person using one hand to a desired location. Further, the air fryer 2 can be employed with a power cord or with batteries to operate the electrical functions of the air fryer 2 and with propane being the fuel source for heating the air fryer. As such, due to the minimal size and weight of the air fryer 2, the air fryer may be highly portable and can readily be placed within the back-seat of a vehicle, for example, to transport to a desired location, such as for tail gaiting, the beach or for camping, or to most any desired location. Such air fryer 2 also may include various heat shield structures in combination with gaps for circulating cool air through portions of the air fryer that may be designed to minimize the temperature of the external surfaces of the air fryer 2.

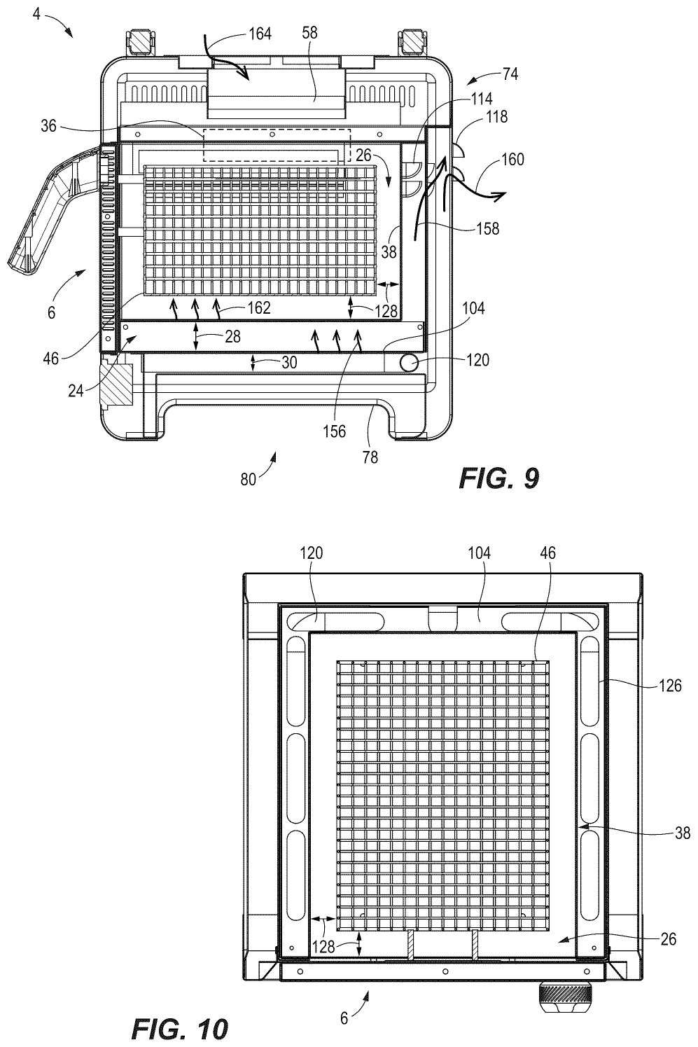

The air fryer 2 may include a main body 4 and a food basket 6. The main body 4 may extend to define an exterior 8 defined by a front wall 10, a rear wall 12, a left wall 14, a right wall 16, an upper wall 18, and a lower wall 20 (FIG. 4). The front wall 10 may define a chamber opening 22 that facilitates access to a portion of an interior 24 of the main body 4. The interior 24 may include a cooking chamber 26 sized and configured for the food basket 6 to be positioned therein. Further, the interior 24 may include a first gap 28 and a second gap 30 configured to facilitate air flow through the first and second gaps 28, 30 and out of the interior 24 of the main body 4. The food basket 6 may include multiple perforations 32 to allow heated air into and out of the food basket 6. An upper chamber 34 may be positioned above the cooking chamber 26 such that a lower fan 36 may be positioned directly adjacent to the cooking chamber 26. The lower fan 36 (FIG. 9) may be configured to direct air from the upper chamber 34 into the cooking chamber 26 to mix heated air within the cooking chamber 26. A burner 120 may be positioned in the second gap 30 below the cooking chamber 26 to heat the air flowing into the interior 24 of the main body 4 and to heat chamber walls 38 of the cooking chamber 26 such that heat from the heated chamber walls 38 may then heat the cooking chamber 26.

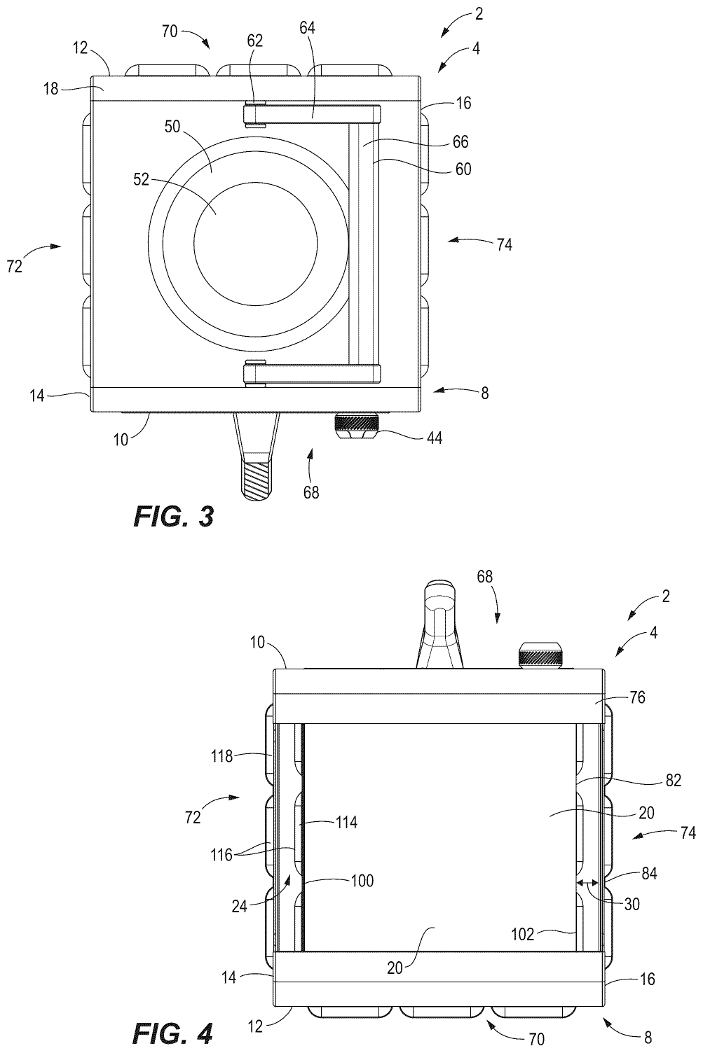

Now with reference to FIGS. 1, 2, and 3, as previously provided, the main body 4 may define the exterior 8 by the front wall 10, rear wall 12, left wall 14, right wall 16, upper wall 18, and lower wall 20 (FIG. 4). The front wall 10, rear wall 12, left wall 14, and right wall 16 may be configured to extend vertically. The front wall 10 and rear wall 12 may be positioned as opposing panels, extending parallel to one another. The left wall 14 and right wall 16 may be positioned as opposing panels, also extending parallel to one another. Further, the front and rear walls 10, 12 may be coupled to the left and right walls 14, 16 on opposing ends. Even further, the front wall 10, the rear wall 12, the left wall 14, and the right wall 16, may extend to the upper wall 18 and lower wall 20 to define an upper periphery 40 and a lower periphery 42, respectively. The upper periphery 40 may define a perimeter of, or structure adjacent thereto, of the upper wall 18. The lower periphery 42 may define a perimeter of, or structure adjacent thereto, of the lower wall 20. Further, portions of the upper wall 18 and lower wall 20 may extend substantially perpendicular relative to the front wall 10, rear wall 12, left wall 14, and right wall 16. With this arrangement, the exterior 8 of the main body 4 may have various panels that extend with a generally cubical shape or generally cuboid shape.

The front wall 10 may extend to include a burner knob 44 and various controls or displays positioned thereon as well as the chamber opening 22 positioned to facilitate access to the cooking chamber 26. Further, the front wall 10 may include an ignitor switch for igniting the burner 120. Such ignitor switch may be integrated in the burner knob 44 such that, upon turning the knob, the ignitor switch may be triggered to ignite fuel flowing through the burner 120. The chamber opening 22 may be sized and configured to receive the food basket 6 to be positioned within the cooking chamber 26. The food basket 6 may include a container portion 46 and a container wall 48. The container wall 48 may be sized to extend over and close-off the chamber 26 and the chamber opening 22. In one embodiment, the container wall 48 may be sized with structure that may nest with the structure surrounding the chamber opening 22. The container portion 46 of the food basket 6 may be sized and configured to be positioned within the cooking chamber 26 the main body 4.

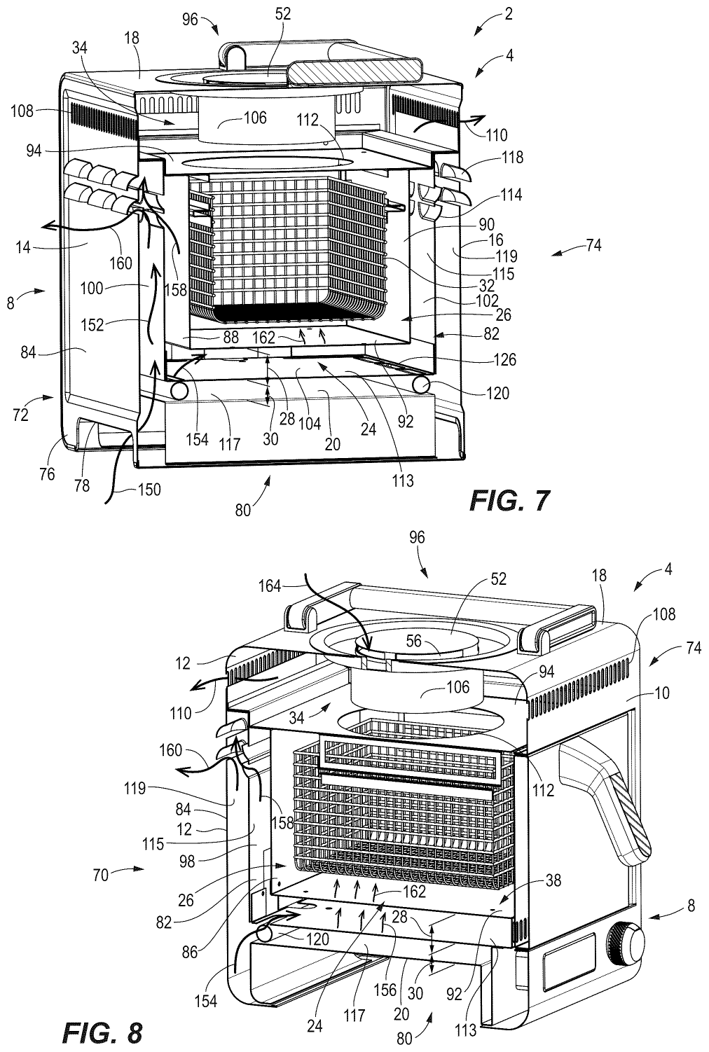

The upper wall 18 may extend to define a channel 50 therein. The channel 50 may be circular in shape (or any other suitable shape) and extend towards the interior 24 of the main body 4 and inward toward a fan housing 52. The fan housing 52 may be generally centered within the channel 50 and centrally formed in or adjacent to the upper wall 18, extending upwards away from the channel 50 such that a top end 54 of the fan housing 52 may be flush with the upper wall 18. The fan housing 52 may be circular in shape and include openings 56 positioned along the fan housing 52. The openings 56 may be configured to allow air into the fan housing 52 such that the air is directed into the interior 24 of the main body 4 so that the air may be directed into the upper chamber 34 (FIG. 7). The lower fan 36 (FIG. 9) may blow air entering from the fan housing 52 into the cooking chamber 26. The fan housing 52 may be configured to protect an upper fan 58 (FIG. 9) and the lower fan 36 (FIG. 9) from the elements. The upper fan 58 (FIG. 9) may be positioned within the fan housing 52 directly above and adjacent the lower fan 36 (FIG. 9). With this arrangement, the upper fan 58 may push air directly onto a motor of the lower fan 36 so that the motor of the lower fan 36 may be cooled by the upper fan 58. Further, the lower fan 36 may push air into the cooking chamber 26 to mix the air within the cooking chamber 26.

The upper wall 18 may also include a carrying handle 60 where the carrying handle 60 may include hinges 62, arms 64, and a cross bar 66. The hinges 62 may be positioned on opposing sides of the main body 4 along the upper wall 18, such as near a front side 68 and a rear side 70 of the main body 4 or a left side 72 and a right side 74 of the main body 4, with the arms 64 coupled to the hinges 62 where the arms 64 may be pivotable from a resting state (as shown) and an upright carrying state. The resting state may be when the arms 64 are extending substantially parallel or resting on the upper wall 18 and the carrying state may be when the arms 64 are extending perpendicular to the upper wall 18. The cross bar 66 may be coupled to the arms 64 such that the hinges 62 and arms 64 on opposing sides may be connected and a user may hold the cross bar 66 to carry the air fryer 2. In this manner, the carrying handle 60 may facilitate portability of the air fryer 2 such that the air fryer may be sized and configured to be readily lifted and moved from one location to another.

Now with reference to FIGS. 4, and 6, the front and rear wall 10, 12 may extend towards the lower periphery 42 to define feet 76 extending a length of the front wall 10 and rear wall 12 or partially along the length of the front and rear walls 10, 12. The feet 76 may be configured to allow the air fryer 2 to be raised or suspended above the surface on which the air fryer 2 may be positioned upon. In one embodiment, the feet 76 may extend continuously along the length of the front wall 10 and rear wall 12. In another embodiment, there may be individual feet 76 extending on opposing ends of the front wall 10 and rear wall 12. The left wall 14 and right wall 16 may extend to the lower periphery 42 to define an airway 78 between the feet 76. The airway 78 may extend between and be defined by the feet 76 on the front wall 10 and rear wall 12. The airway 78 may be configured to allow air flow underneath the main body 4 and into openings leading into the interior 24 of the main body 4.

With reference to FIGS. 4, 6 and 7, the lower wall 20 of the main body 4 may be set into the interior 24 of the main body 4 such that the interior 24 may be open or exposed along a lower side 80 of the main body. The lower side 80 of the main body 4 being open may allow air to be drawn or flow into the interior 24 of the main body 4. The lower wall 20 may be positioned at least partially above the airway 78 such that when positioned on a surface, such as a countertop, the lower wall 20 may be suspended above the surface on which the main body 4 has been placed. Further, the lower wall 20 may extend a substantial amount over the lower side 80 and may provide further assistance in directing air flow into the interior 24 of the main body 4 by drawing air towards and into the second gap 30. The second gap 30 may extend between an inner shield 82 and an outer shield 84, where the outer shield 84 may be the exterior walls of the main body 4. The second gap 30 may extend at least on the left side 72 and right side 74 of the main body 4, or, the second gap 30 may extend continuously on the rear side 70, left side 72, and right side 74 of the main body 4.

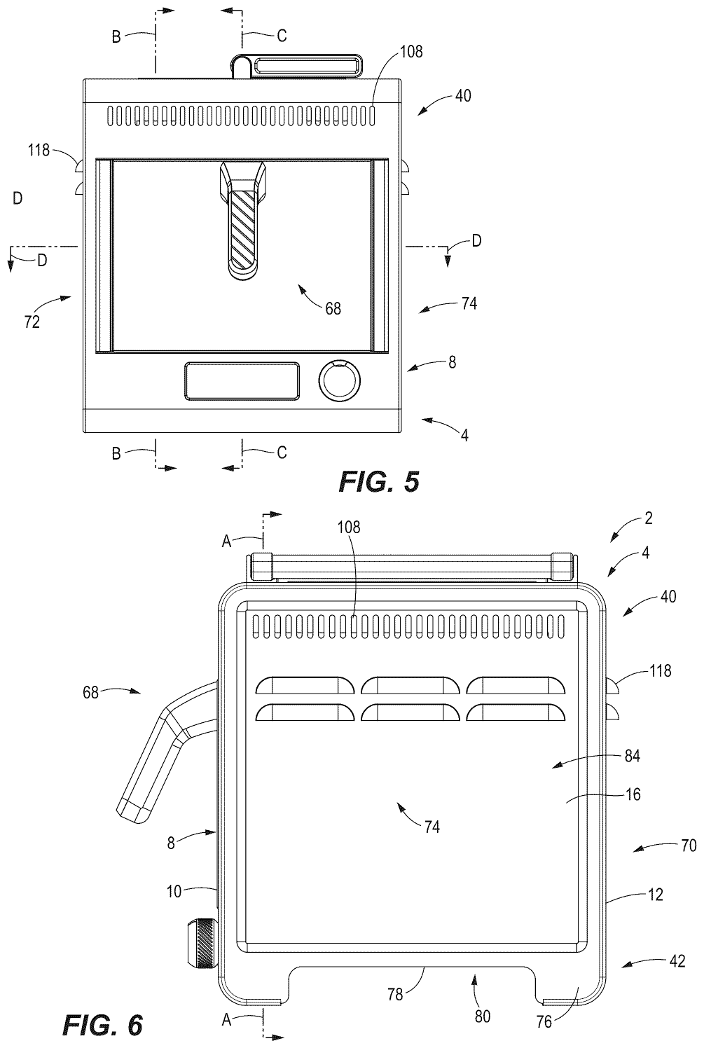

Now with reference to FIGS. 5, and 6, the upper periphery 40 of the main body 4 may include through holes 108 defined therein extending from the exterior 8 to the interior 24 of the main body 4. The through holes 108 may extend along the length of the front side 68, rear side 70, left side 72, and right side 74 of the main body 4, or, in other embodiments, along the lengths of the front side 68, left side 72, and right side 74 of the main body 4. Further, the through holes 108 may be sized and configured to direct air flow out of the interior 24 (FIG. 2) of the main body 4 from air flow of the upper fan 58. The upper periphery 40 of the rear side 70, left side 72, and right side 74, may also include outer vents 118. The outer vents 118 may extend from the exterior 8 of the main body 4 into the interior 24 (FIG. 2) of the main body 4. Further, the outer vents 118 may extend from the exterior 8 of the main body 4 to the second gap 30 (FIG. 7) of the interior 24 (FIG. 2) of the main body 4. In other embodiments, the outer vents 118 may be positioned on the left side 72 and right side 74. The outer vents 118 may be configured to direct and draw air out from the interior 24 (FIG. 2) of the main body 4.

With reference to FIGS. 7 and 8, the interior 24 of the main body 4 may include a cooking chamber 26, the inner shield 82, and the outer shield 84. The cooking chamber 26 may extend with the chamber walls 38 to define a rear chamber wall 86, a left chamber wall 88, a right chamber wall 90, a lower chamber wall 92, and an upper chamber wall 94. The rear chamber wall 86, left chamber wall 88, and right chamber wall 90 may extend substantially parallel to the rear wall 12, left wall 14, and right wall 16, respectively. The lower chamber wall 92 and the upper chamber wall 94 may extend substantially parallel to the lower wall 20 and the upper wall 18, respectively. Further, each of the rear chamber wall 86, the left chamber wall 88, the right chamber wall 90, the lower chamber wall 92 and the upper chamber wall may correspond with the respective rear side 70, the left side 72, the right side 74, the lower side 80 and an upper side 96 of the main body 4. With this arrangement, along with the container wall 48 of the food basket 6, the chamber walls 38 may extend with a substantially cubical structure to define a cubical or cuboid cooking chamber of the type where the chamber walls may (or may not) be the same length.

In addition, the panels of the inner shield 82 may extend substantially parallel to corresponding ones of the chamber walls 38 that define the cooking chamber 26 at a distance which may define the first gap 28. For example, the inner shield 82 may extend to define a rear inner shield 98, a left inner shield 100, a right inner shield 102, and a lower inner shield 104 that may extend substantially parallel to the rear chamber wall 86, left chamber wall 88, right chamber wall 90, and lower chamber wall 92, respectively. With this arrangement, the first gap 28 may extend with a horizontal first gap portion 113 defined and extending between the lower inner shield 104 and the lower chamber wall 92. Further, the horizontal first gap portion 113 may continuously extend to vertical first gap portions 115 each of which may be defined between the respective rear inner shield 98 and the rear chamber wall 86, the respective left inner shield 100 and the left chamber wall 88, and the respective right inner shield 102 and the right chamber wall 90. As such, the first gap 28 may extend to define both the horizontal first gap portion 113 and multiple vertical first gap portions 115.

The outer shield 84 may also be the exterior 8 of the main body 4 such that the outer shield 84 may extend with panels that extend substantially parallel to the panels of the inner shield 82 at a distance to define the second gap 30. For example, the rear wall 12, the left wall 14, the right wall 16, and the lower wall 20 may extend substantially parallel to the rear inner shield 98, the left inner shield 100, the right inner shield 102, and lower inner shield 104, respectively. With this arrangement, the second gap 30 may extend with a horizontal second gap portion 117 defined between the respective lower inner shield 104 and the lower wall 20. Further, the horizontal second gap portion 117 may continuously extend to vertical second gap portions 119. Each of the vertical second gap portions 119 may extend between the respective rear inner shield 98 and the rear wall 12, the respective left inner shield 100 and the left wall 14, and the respective right inner shield 102 and the right wall 16. As such, the second gap may extend to define both the horizontal second gap portion 117 and the multiple vertical second gap portions 119. Further, with this arrangement, the inner shield 82 and outer shield 84 may be sized and configured to act as heat shields to create a barrier relative to the cooking chamber 26 to minimize the heat reaching the panels of the exterior 8 in the main body 4 and to direct and manipulate heated air from the respective first and second gaps 28, 30 via vents to flow outside the main body 4.

The upper chamber wall 94 may extend between the front wall 10 and the rear wall 12 and between the left wall 14 and the right wall 16 of the main body 4 and may extend over the cooking chamber 26 as well as the vertical portions of the first gap 28 and the second gap 30. The upper chamber 34 may be defined by the outer shield 84, or exterior walls such as the front, rear, left, right, and upper walls 10, 12, 14, 16, 18 of the main body 4, and the upper chamber wall 94 such that the upper chamber 34 may be positioned in the interior 24 of the main body 4. The upper chamber 34 may include the fan housing 52 extending from the upper wall 18 into the upper chamber 34 towards the upper chamber wall 94. The fan housing 52 may include a duct 106 extending within the upper chamber 34 towards the upper chamber wall 94. The duct 106 may be sized and configured for one or more fans to be positioned therein directing air entering from the openings 56 of the fan housing 52 into the upper chamber 34. The upper chamber 34 may include through holes 108 extending from the interior 24 of the main body 4, or the upper chamber 34, to the exterior 8 of the main body 4. The through holes 108 may be configured to direct air from the upper chamber 34 to the exterior 8 of the main body 4 as shown by arrow 110.

With reference to FIGS. 7-9, the upper chamber wall 94 may include a hole 112 defined therein and positioned beneath the fan housing 52 where the hole 112 is sized and configured to direct air into the cooking chamber 26. In other embodiments, the hole 112 may also be sized and configured for a fan to be positioned therein. The upper fan 58 may be positioned within the duct 106 of the fan housing 52 and may be configured to direct air into the upper chamber 34 and keep a motor of the lower fan 36, depicted with dashed lines, from overheating. The lower fan 36 may be positioned in either the duct 106 of the fan housing 52 below the upper fan 58, or, in other embodiments, in the hole 112 of the upper chamber wall 94 below the upper fan 58. Further, the lower fan 36 may be configured to mix heated air in the cooking chamber 26 to achieve a more even cooking of the food.

With reference to FIGS. 2, 4, and 7, the rear, left, and right inner shield 98 (FIG. 8), 100, 102 may extend from the lower inner shield 104 to the upper chamber wall 94. The inner shield 82 may define inner vents 114 extending from the first gap 28 to the second gap 30 and may be configured to direct air from the first gap 28 into the second gap 30. The inner vents 114 may include vent flares configured in an outward and upward position. The upward flare position of the inner vents 114 assists in the air flow from the first gap 28. As previously stated, the outer shield 84, also being the exterior 8 of the main body 4, may extend past the upper chamber wall 94 to the upper wall 18 of the main body 4 to partially define the upper chamber 34. The outer shield 84 may define the second gap 30. The second gap 30 may extend from the feet 76 of the main body 4 (or adjacent thereto) to the upper chamber wall 94 such that the second gap 30 may be closed-off at or adjacent to the upper chamber 34. The outer shield 84 may include outer vents 118 with the vent flares configured to extend in an outward and downward position. The downward flare position of the outer vents 118 may be along the exterior 8 of the main body 4 and, as such, may substantially prevent moisture, such as rain water, from entering the second gap 30 while still facilitating air flow therethrough. In this manner, the outer vents 118 may extend from the second gap 30 to the exterior 8 of the main body 4 and may be configured to direct and draw air from the second gap 30 to the exterior 8 of the main body 4.

As previously set forth, the air fryer 2 may be heated with a gas-powered burner 120. In other embodiments, the air fryer 2 may employ other types of burners or heating elements, such as an electrical burner or electrical heating element. The burner 120 may be coupled to the main body 4 and may be activated with the burner knob 44 (FIG. 1). The burner 120 may be associated with structure for feeding pressurized fuel thereto, such as propane gas or natural gas, and controlled with the burner knob 44. Further, the burner knob may be employed with an ignitor switch associated therewith such that turning the burner knob 44 to an on position may also activate the ignitor. Further, the air fryer 2 may include typical components to facilitate activating the burner 120 such as, various valves and tubing, gas couplings, fasteners, and any other components, as known to one of ordinary skill in the art.

The burner 120 may be positioned within the second gap 30 between the lower inner shield 104 and the lower wall 20 of the outer shield 84, or exterior 8. The burner 120 may extend in different configurations such as a u-shaped burner extending along the rear side 70, left side 72, and right side 74. The lower inner shield 104 may extend from the rear inner shield 98 (FIG. 8) to the chamber opening 22. As best shown in FIG. 2, the chamber opening 22 may include a gap panel 122 positioned over the first gap 28 such that the first gap 28 may be closed-off from the chamber opening 22 or the front side 68 of the main body 4. The gap panel 122 may extend from the left inner shield 100, right inner shield 102, and lower inner shield 104 to the left chamber wall 88, right chamber wall 90, and lower chamber wall 92. The gap panel 122 may include gap through holes 124, the gap through holes 124 positioned on the gap panel 122 between the lower inner shield 104 and the lower chamber wall 92. In other embodiments, the gap through holes 124 may be positioned on the gap panel 122 such as between the left inner shield 100, right inner shield 102, and lower inner shield and the chamber walls 38, or, between the left inner shield 100 and right inner shield 102 and the chamber walls 38. Further, the gap through holes 124 may be configured to ventilate the first gap 28. In another embodiment, upon the food basket 6 being removed, the gap through holes 124 may be sized and configured to facilitate the user to view therethrough so one can see if the burner 120 has been ignited.

Now with reference to FIGS. 9 and 10, the lower inner shield 104 may extend to include burner vents 126. The burner vents 126 may extend through the second gap 30 to the first gap 28 and may be positioned over the burner 120 such that heat from the burner 120 may travel from the burner 120 in the second gap 30 to the first gap 28. The heat traveling from the burner 120 through the burner vents 126 may heat the chamber walls 38 of the cooking chamber 26. The cooking chamber 26 may be sized for the food basket 6 to be positioned therein such that when the food basket 6 has been positioned, a space 128 may be defined between the container portion 46 of the food basket 6 and the chamber walls 38. The space 128 may extend from the chamber walls 38 to the container portion 46 such that the space 128 is equidistant on all sides of the container portion 46 so that the air may be mixed and moved around the container portion 46 of the food basket 6 so as to heat the container portion 6 and food therein in a substantially even manner. Further, the space 128 may extend from the chamber walls 38 to the container portion 46 at an optimal length for cooking food, therefore, the space 128 may not be positioned close or far away to the chamber walls 38 such that food may be cooked unevenly.

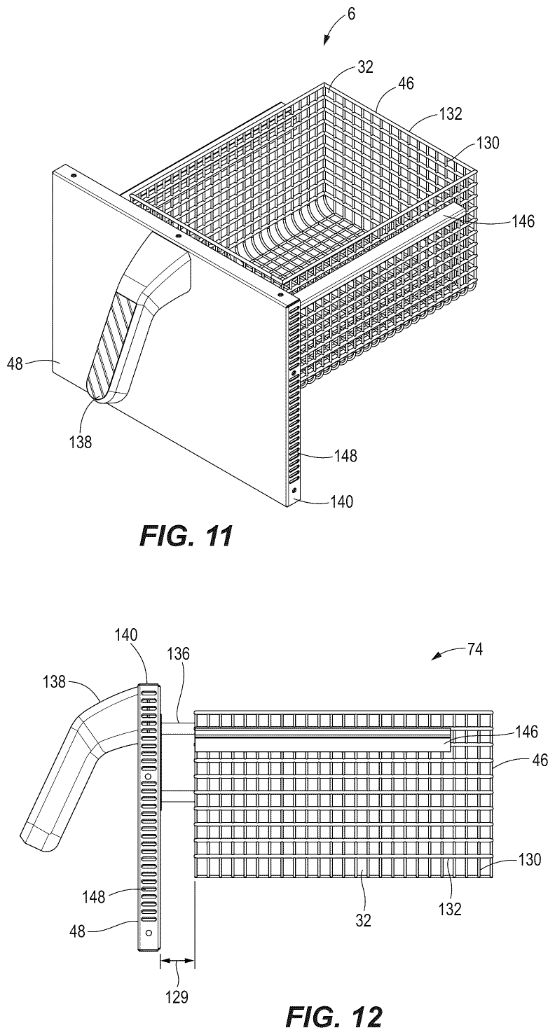

With reference to FIGS. 11 and 12, the food basket 6 may include the container portion 46 and the container wall 48. The container portion 46 may include laterally extending wires 130 and longitudinally extending wires 132 extending and crossing over one another so that the container portion 46 may define multiple perforations 32 therein. As such, the container portion 46 exhibits a multi-cellular structure to facilitate air flow to readily pass through the container portion 46 to effectively heat food in a substantially even manner within the container portion 46. The container wall 48 may be coupled to the container portion 46 by bars 136 extending from the container wall 48 to the container portion 46. The bars 136 may extend to define the space 129 between the container wall 48 to the container portion 46. The space 129 may be sized similarly to spaced 28, discussed previously. The container wall 48 may be sized and configured to fit into the chamber opening 22 (FIG. 2) such that the container wall 48 may close-off the chamber opening 22 (FIG. 2) from the exterior 8 (FIG. 2) of the main body 4 (FIG. 2) when the container portion 46 of the food basket 6 is positioned and enclosed within the chamber 26. Further, the container wall may include a handle 138 sized and configured to facilitate a user to grip when removing and inserting the food basket 6 relative to the chamber 26.

Now with reference to FIGS. 2, 11, and 12, as previously provided, the container portion 46 of the food basket 6 may be sized and configured to be positioned within the cooking chamber 26 of the main body 4 such that the container wall 48 may close-off the chamber opening 22. The container wall 48 may extend to define a depth 140 sized to be substantially similar to a ledge 142 defined as structure along the periphery of the chamber opening 22. The depth 140 of the container wall 48 may rest on the ledge 142 and provide some stability to the food basket 6 as the food basket 6 is set within the cooking chamber 26. Further, the depth 140 may include container wall through holes 148 sized and configured to ventilate heat from the container wall 48. Such container wall through holes 148 may be defined in the depth 140 of the container wall 48 along opposing sides (or left and right sides) thereof. In another embodiment, the container wall through holes 148 may be defined in the depth 140 of the container wall 48 along the upper and/or lower sides of the container wall 48. Further, the cooking chamber 26 may include a chamber slide member 144 positioned on the left and right chamber walls 88, 90 and the container portion 46 of the food basket 6 may include a basket slide member 146. The chamber slide member 144 may receive the basket slide member 146 such that the chamber slide member 144 may assist in stability to position and hold the food basket 6 when positioned within the cooking chamber 26. Further, the chamber slide 144 and the corresponding basket slide 146 may facilitate consistent positioning of the basket 6 within the cooking chamber 26.

Now with reference to FIGS. 7, 8, and 9, the description of the direction of air flow from the exterior 8 of the main body 4 through a variety of air ways, through holes, and vents is provided. The air flow may enter into the interior 24 of the main body 4 by way of the airway 78 on the lower side 80 of the main body 4, as shown by arrow 150. The air may be drawn through the airway 78 and into the second gap 30 of the interior 24 of the main body 4. The air may then be directed and drawn upwards in the second gap 30 towards the upper chamber wall 94, as shown by arrow 152. Further, in another embodiment, the air may be warmed by the burner 120 and flow through the burner vents 126 into the first gap 28, as shown by arrow 154. The air flow, shown by arrow 152, may assist in keeping the second gap 30 cool and the outer shield 84 from overheating. Further, the air flow, shown by arrow 154, may be heated with the burner 120 positioned along the burner vents 126 so that the air flow may move along and heat the chamber walls 38 of the cooking chamber 26. The burner 120 may also heat the lower inner shield 104 such that the lower inner shield 104 may radiate heat toward the chamber walls 38 and the cooking chamber 26, as shown by arrows 156. The heated air in the first gap 28 may move along the horizontal portion of the first gap 28 and upward along the vertical portions of the first gap 28 to heat the chamber walls 38 (which radiates heat inward from the chamber walls 38 in the cooking chamber 26) to then exit the first gap 28 and enter the second gap 30 through the inner vents 114, as shown by arrow 158. The heated air exiting the first gap 28 may be cooled by the air flow, shown by arrow 152. The inner shield 82 may act as a heat shield relative to the outer shield 84 and exterior 8 of the main body 4 while also acting to contain the heat within the first gap 28 to heat the chamber walls 38 of the cooking chamber 26. A such, the air flow along the second gap 30 may be intended to act as a cooling gap such that the second gap may operate with a cooler temperature than the first gap 28. The air flow along the second gap may be drawn upward, as depicted by air flow arrows 150 and 152 to move from the second gap 30 to exit through the outer vents 118, as depicted by arrow 160.

The chamber walls 38 of the cooking chamber 26 may be heated by heated air in the first gap 28, as shown by arrow 154, and the radiated heat from the lower inner shield 104, as shown by arrow 156. The heat of the chamber walls 38 may be radiated from the chamber walls 38 into the cooking chamber 26 toward the food basket 6, as shown by arrow 162. Further, air from the exterior 8 of the main body 4 may enter into the upper chamber 34 through the openings 56 positioned on the fan housing 52, as shown by arrow 164, the air flow being directed by the upper fan 58 to the motor of the lower fan 36 to keep such motor of the lower fan 36 cool. As heat naturally rises in the cooking chamber 26, the upper chamber 34 may begin to warm, the air may exit the upper chamber 34 through the through holes 108 positioned on the upper chamber 34, as shown by arrow 110. The space 128 between the chamber walls 38 and the container portion 46 of the food basket 6 and the space 129 between the container wall 48 and the container portion 46 of the food basket 6 may provide substantially even cooking in conjunction with the lower fan 36 mixing the radiated heat coming off of the chamber walls 38 within the cooking chamber 26. In this manner, the air fryer 2 includes structure to facilitate effective heating of the cooking chamber 26 while also drawing cool air, as shown by arrow 152, through the vertical second gap portions 119 of the second gap 30 to minimize heating the exterior of the air fryer 2.

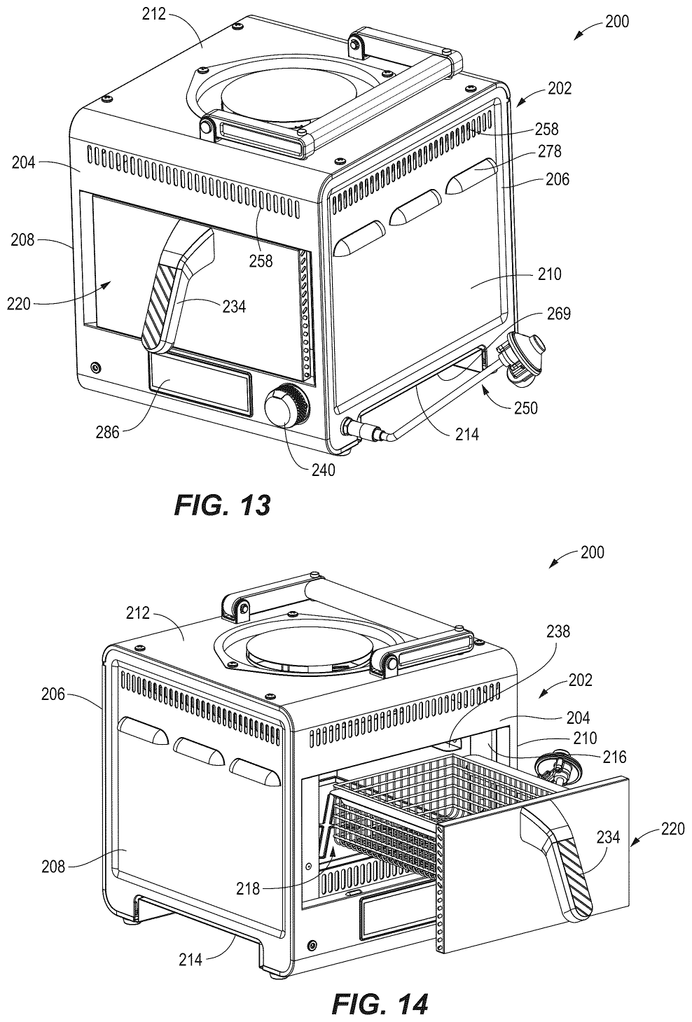

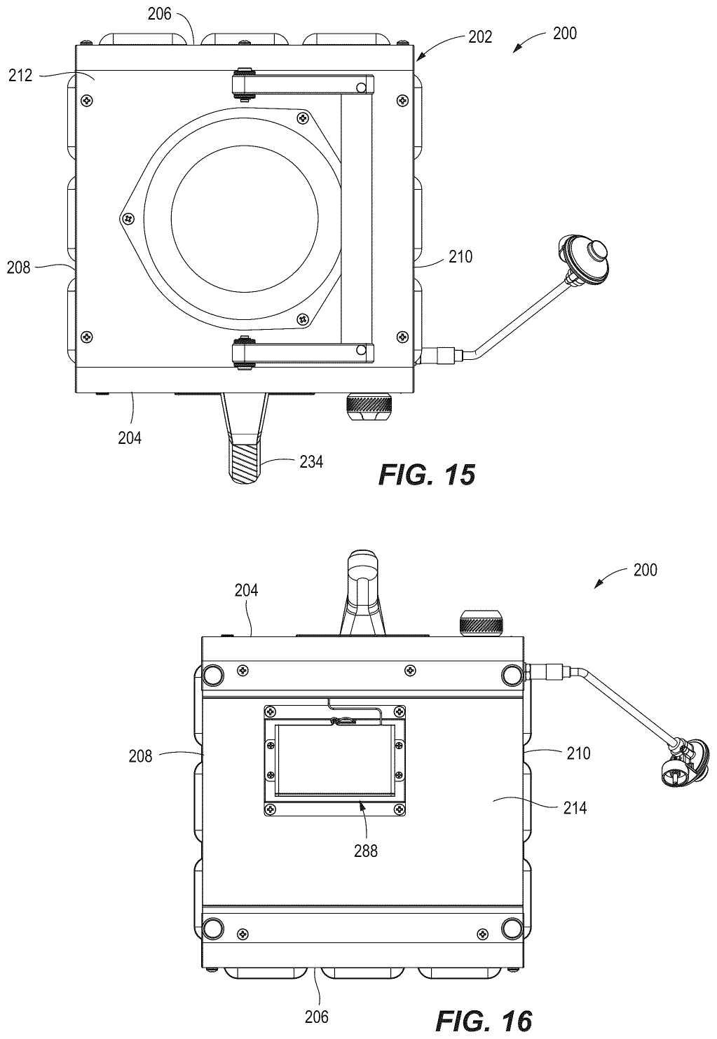

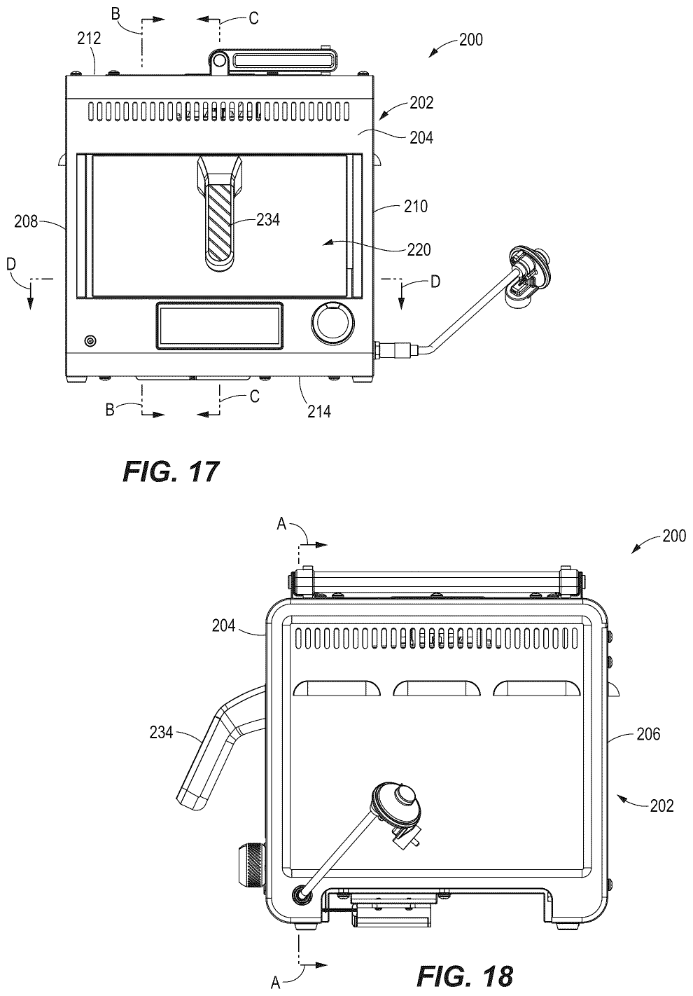

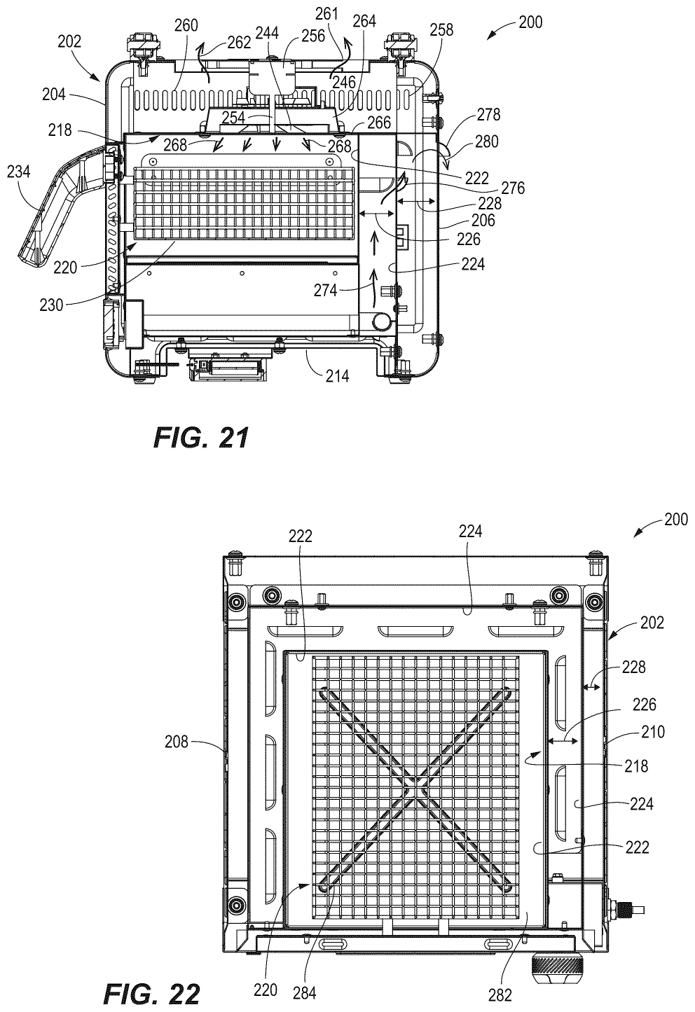

Now with reference to FIGS. 13-24, another embodiment of an air fryer 200 is provided. This embodiment of the air fryer 200 may include similar structural and functional features as the embodiment described and depicted relative to FIGS. 1-12 and, as such, the description of the various structural features and functions of the previous embodiment may apply to corresponding similar structural features and functions of this embodiment. For example, the air fryer 200 of this embodiment may include a main body 202 extending with multiple panels to define interior and exterior walls such as, a front wall 204, a rear wall 206, a left wall 208, a right wall 210, an upper wall 212 and a lower wall 214. The front wall 204 may define a chamber opening 216 for accessing a cooking chamber 218. The cooking chamber 218 may be sized and configured to hold a fryer basket 220 or food basket therein. Such fryer basket 220 may move between an engaged position and a disengaged position relative to the cooking chamber 218. The engaged position of the fryer basket 220 may be a use position or the position of the fryer basket 220 when cooking food within the cooking chamber 218 of the air fryer 200 or the position of the fryer basket 220 to be maintained within the cooking chamber 218 of the air fryer 200 while not in use. The disengaged position of the fryer basket 220 may be the position of the fryer basket 220 removed from the cooking chamber 218 of the air fryer 200.

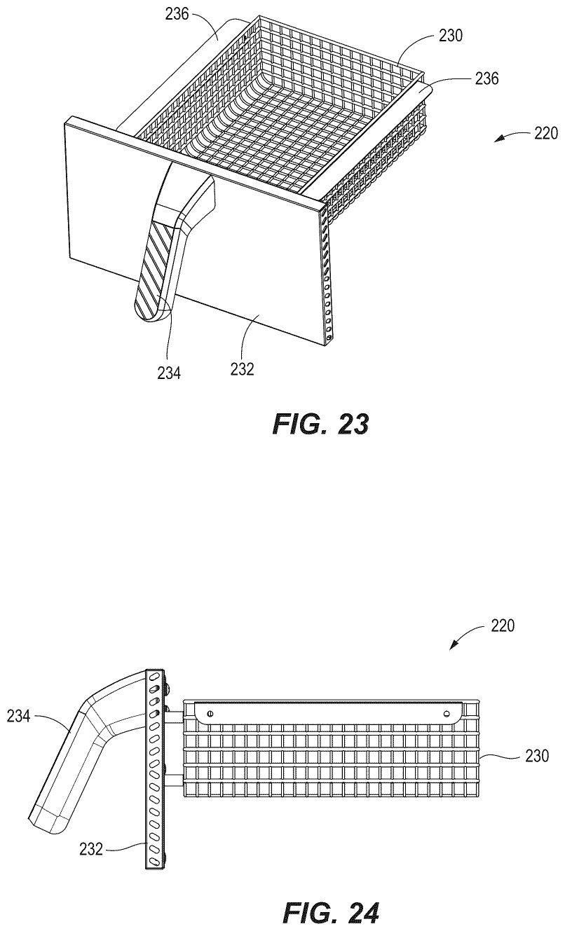

Further, similar to the previous embodiment, the main body 202 of the air fryer 200 may also include chamber walls 222 and a heat shield 224, the heat shield 224 positioned between the chamber walls 222 and the exterior walls to define an inner gap 226 and an outer gap 228. The inner gap 226 may extend between the chamber walls 222 and the heat shield 224. The outer gap 228 may extend between the heat shield 224 and the exterior walls. The fryer basket 220 may include a basket container portion 230 and a container wall 232 with a handle 234. The basket container portion 230 may be a wire basket to define openings or perforations therein so that the basket container portion 230 may facilitate air flow that may freely flow through the container portion 230 of the fryer basket 220 so that air may freely move around food items within the fryer basket 220. The basket container portion 230 of this embodiment may be similar to the previous embodiment, except the container portion 230 of this embodiment may be more shallow in depth than the previous embodiment, as depicted in FIGS. 23 and 24. Such fryer basket 220 may include basket rails 236 on opposite sides of the container portion 230 that may be sized and configured to correspond with chamber rails 238 positioned in the cooking chamber 218. Such basket rails 236 may facilitate the fryer basket 220 to glide on the chamber rails 238 so that the fryer basket 220 can readily be moved between the engaged and disengaged positions relative to the cooking chamber 218 of the air fryer 200.

With reference to FIGS. 13 and 19-21, the air fryer 200 of this embodiment may include a burner knob 240, a gas burner 242, a lower fan 244 and an upper fan 246. The burner knob 240 may be coupled to the gas burner 242, the gas burner 242 being in the form of a tube that may be interconnected to a gas control valve (not shown) and a regulator assembly 250. The regulator assembly 250 may be sized and configured to removably connect to a portable propane tank, such as a one-pound propane tank. With appropriate adapters and valving, other sized propane tanks may also be coupled to the air fryer 200, as known to one of ordinary skill in the art. The gas control valve may include a solenoid type valve that may be associated with one or more sensors to control opening and closing the valve to funnel gas therethrough or to stop gas from flowing through the gas control valve, discussed further herein. The gas burner 242 may be positioned within the inner gap 226 between the chamber walls 222 and the heat shield 224. Such inner gap 226 with its gas flame burner 242 positioned therein may be referenced as a burner chamber, which may include the space below a lower one of the cooking chamber walls 222 and a burner chamber wall 290 (FIG. 20). As such, the burner chamber surrounds the cooking chamber walls 222. The burner knob 240 may be associated with an ignitor (not shown) for igniting gas flowing through the gas burner 242, as known to one of ordinary skill in the art. Such ignitor may be activated automatically upon a user turning the burner knob, for example.

The lower fan 244 and the upper fan 246 may both be coupled to a shaft 254. The shaft 254 may be driven to rotate about an axis defined by the shaft 254 to be rotated by a motor 256. The upper fan 246 may push air upward toward the motor 256 to assist in cooling the motor 256. Such air may be drawn externally, such as through upper vents 258 defined in external walls and, along left and right sides of the air fryer 200, through inner upper vents 260 defined in upper heat shield portions, and then moving over the motor 256 via the upper fan 246 and out through top vents 261, as shown by arrow 262. The lower fan 244 may be positioned within a lower fan housing 264 that may encapsulate or surround the lower fan 244 so as to be coupled directly, in a sealing manner, to an upper chamber wall 266 of the cooking chamber 218 such that the lower fan 244 may blow or push air directly into the cooking chamber 218, as shown by arrow 268, to mix air within the cooking chamber 218. As such, the air in the cooking chamber 218 is being mixed by the lower fan 244 and not circulated from other locations of the air fryer 200.

Further, as in the previous embodiment, air may be drawn through lower vents 269 to feed oxygen to the gas burners 242, as shown by arrow 270. The gas burner 242 may generate heat for heating the cooking chamber walls 222 with heat flowing below the cooking chamber 218, as shown by arrow 272, and along side chamber walls 222 within the inner gap 226, as shown by arrow 274. As such, the heat may funnel upward through the inner gap 226 and through heat shield vents 276 to flow into the outer gap 228 and then through outer vents 278, as shown by arrow 280. Such heat flowing upward through the heat shield vents 276 and then through the outer vents 278 may draw cool air through the outer gap 228 from the lower vents 269, as shown by arrow 281. Such cool air being drawn through the outer gap 228 may assist in cooling the external walls, as in the previous embodiment.

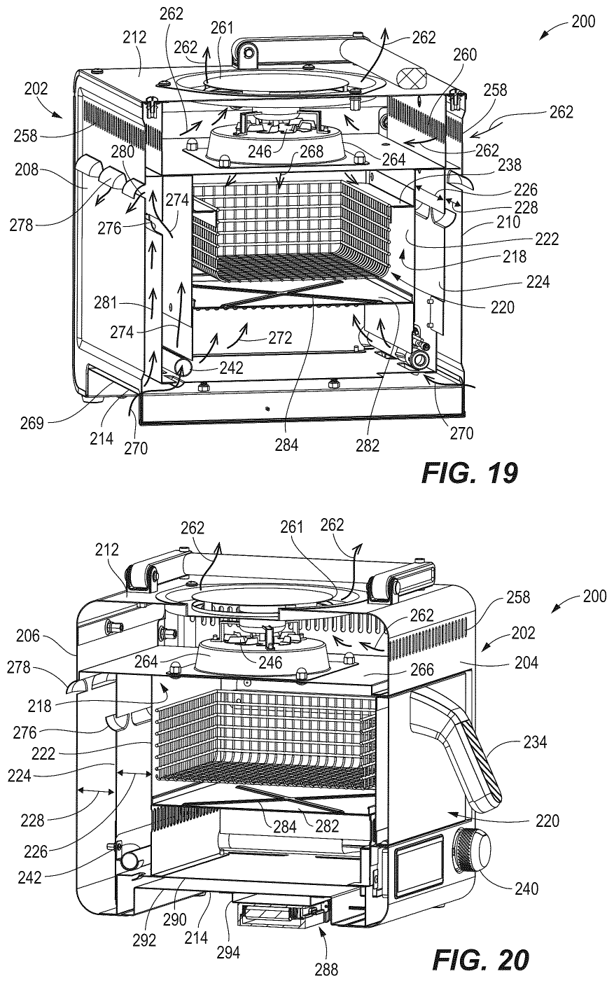

With respect to FIGS. 19, 20 and 22, the cooking chamber may include a drip tray 282 that may sit on a lower cooking chamber wall of the cooking chamber walls 222 of the cooking chamber 218. The drip tray 282 may act to catch drips and crumbs from food items in the fryer basket 220 and may be removable from the cooking chamber 218 for cleaning purposes. Further, the drip tray may include an x-structure 284 associated therewith. Such x-structure 284 may assist in strengthening the drip tray 282 from becoming warped and, as such, the drip tray 282 may undergo severe temperature changes undergo severe thermal stress to maintain its flat structure. As such, the x-structure 284 of the drip tray 282 may minimize the effects of thermal stress upon the drip tray 282. In one embodiment, the drip tray 282 may extend with a sheet material such that the x-structure 284 may be a stamped impression in the sheet material. In another embodiment, the drip tray 282 may extend with a sheet material such that the x-structure 284 may be a secondary structure that may be coupled to the sheet material via welding.

With reference to FIGS. 13, 16 and 20, the air fryer 200 may include a display 286. Such display 286, and other components of the air fryer 200, such as the lower and upper fans 244, 246, the gas control valve, etc., may be powered by a power cord (not shown) and/or batteries. The batteries may be maintained within a battery box 288 positioned along an underside of the air fryer 200. To assist in minimizing heat from conducting toward the batteries within the battery box 288, there may be multiple heat shields along an underside of the air fryer 200 to minimize heating the batteries and the components associated with the battery box 288. For example, the air fryer 200 may include a lower burner chamber wall 290 and a lower heat shield 292 or lower burner chamber wall that may be spaced from the lower burner chamber wall 290. The battery box 288 may include a box heat shield 294, that may be spaced paneling positioned against or adjacent to the lower heat shield 292. With this arrangement, the air fryer 200 may be powered with batteries positioned in the battery box 288, the batteries being shielded from the heat generated by the air fryer 200.

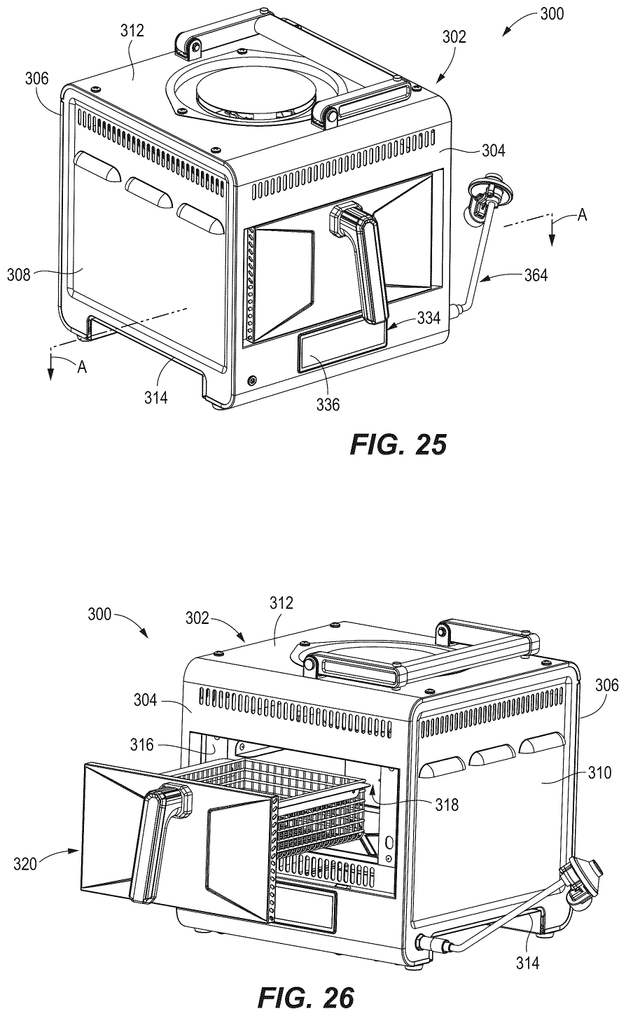

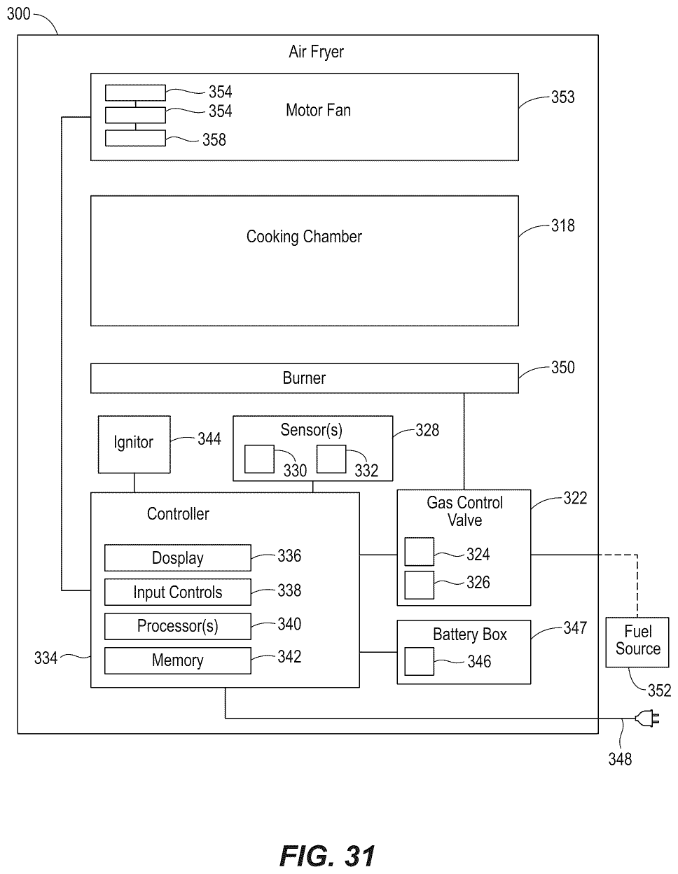

Now with reference to FIGS. 25-31, another embodiment of an air fryer 300 is provided. This embodiment of the air fryer 300 may include similar structural and functional features as the embodiments described and depicted relative to the previous figures and, as such, the description of the previous embodiments may also apply to this embodiment. For example, the air fryer 300 may include a main body 302 extending with multiple panels to define interior and exterior walls. The exterior walls may include a front wall 304, a rear wall 306, a left wall 308, a right wall 310, an upper wall 312 and a lower wall 314. The front wall 304 may define a chamber opening 316 for accessing a cooking chamber 318. The cooking chamber 318 may be sized and configured to hold a fryer basket 320 or food basket therein. The structure within the exterior walls of the air fryer 300 of this embodiment may be substantially the same as the previous embodiment, except the air fryer 300 of this embodiment may not include a burner control knob and, in some embodiments, there may be some additional functionality with a control valve employed with the air fryer 300.

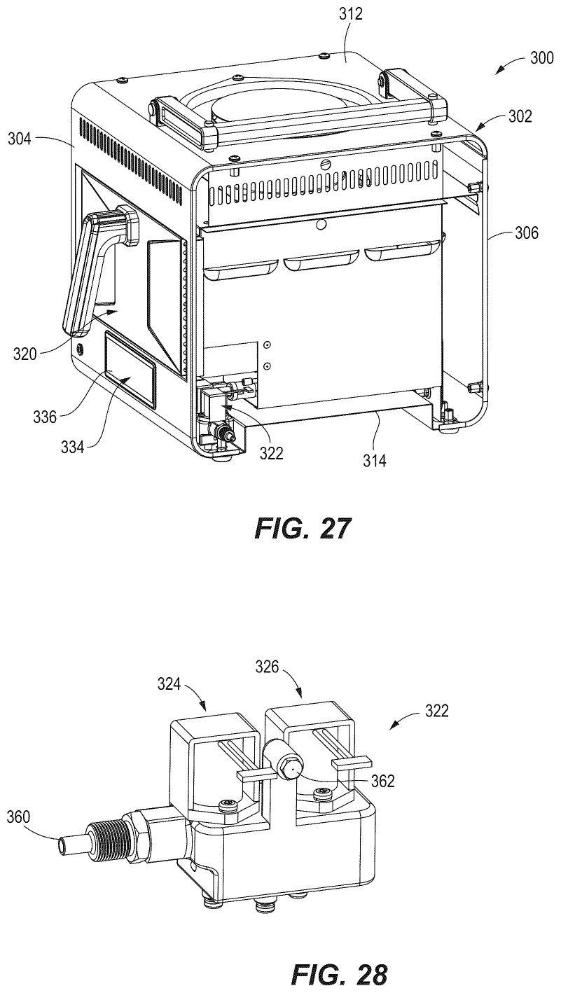

For example, with respect to FIGS. 27, 28 and 31, this embodiment of the air fryer 300 may include a gas control valve 322 with a solenoid portion 324 and a stepper portion 326. Such solenoid portion 324 and stepper portion 326 of the gas control valve 322 may be referenced as a first valve portion and a second valve portion. Further, such solenoid portion 324 of the gas control valve 322 may be employed, at least in part, as a safety feature that may act in conjunction with one or more sensors 328, such as a flame sensor 330 and a temperature sensor 332. The stepper portion 326 of the gas control valve 322 may facilitate maintaining a desired temperature in the cooking chamber 318 of the air fryer 300. Further, the air fryer 300 may include a controller 334, the controller 334 configured to control the various components of the air fryer 300. The controller 334 may include a display 336 that may include input controls 338 associated therewith. The controller 334 may include one or more processors 340 and memory 342. The one or more processors 340 may include programmed software implemented therewith to provide user controls at the display 336 and functionality associated with the various components coupled to the controller 334, as known to one of ordinary skill in the art. The controller 334 may be coupled to an ignitor 344, the one or more sensors 328, and the gas control valve 322. The controller 334 and the air fryer 300 may be powered with batteries 346 within a battery box 347 or may include a power cord 348 for connecting to a power outlet. The gas control valve 322 may be coupled to the controller 334 and the burner 350 and may be removably coupled to a fuel source 352, such as propane or natural gas. It is contemplated that the fuel source 352 may be a one-pound propane tank, or the like. Further, similar to previous embodiments, the controller 334 of the air fryer 300 may be coupled to a motor fan 353 having a motor 354 configured to drive upper and lower fans 356, 358, the lower fan 358 to mix air within the cooking chamber 318 and the upper fan 356 to cool the motor 354, similar to previous embodiments. Also, the cooking chamber 318 may be heated with the burner 350 positioned below the cooking chamber 318 that may be ignited with the ignitor 344.

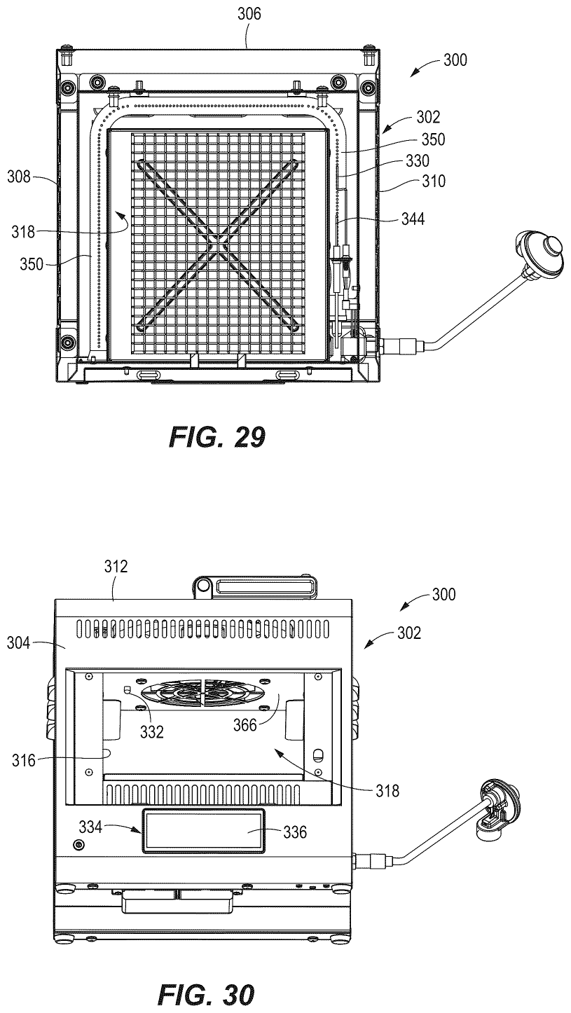

As set forth, the gas control valve 322 may include the solenoid portion 324 and the stepper portion 326. The gas control valve 322 may include an input 360 and an output 362. The input 360 may be configured to be connected to tubes of the regulator assembly 364 (FIG. 25). The output 362 may be configured to be coupled to the lines or tubing of the gas flame burner 350. As previously described, the controller 334 may be coupled to the one or more sensors 328, such as the flame sensor 330 and the temperature sensor 332. The flame sensor 330 or ion sensor may be positioned adjacent to the gas flame burner 350 such that the flame sensor 330 can sense whether or not there is a flame present at the gas flame burner 350 (see FIG. 29). The temperature sensor 332 may be positioned along or adjacent a surface of the cooking chamber 318, such as an upper surface 366 of the cooking chamber 318 of the air fryer 300 (see FIG. 30). Such temperature sensor 332 may be a thermocouple.

With reference to FIGS. 25 and 29-31, upon the air fryer 300 being turned on via user input controls 338 of the display 336 and the air fryer 300 initiated to begin heating, the gas may flow through the gas control valve 322 and the ignitor 344 may ignite a flame at the gas burner 350. If a flame is not sensed with the flame sensor 330 for an initial time period, such as five seconds, the solenoid portion 324 of the gas control valve 322 may shut-off the flow of gas through the gas control valve 322. Further, at anytime when the gas is flowing through the gas control valve 322, but a flame is not sensed by the flame sensor 330 for a period of time, such as five seconds, the controller 334 may automatically trigger the solenoid portion 324 of the gas control valve 322 to block or turn-off gas flowing therethrough. As such, the solenoid portion 324 of the gas control valve 322 may act as a safety feature of the air fryer 300. In another embodiment, upon the user setting a desired temperature at the display 336 of the controller 334 to heat the cooking chamber 318 for a period of time, for example, the temperature sensor 332 may sense the actual temperature of the cooking chamber 318 of the air fryer 300. The gas control valve 322 may remain open to flow gas therethrough to the gas flame burner 350 to heat the cooking chamber 318 until the actual temperature reaches the desired temperature. Upon the actual temperature reaching or moving above the desired temperature, the stepper portion 326 of the gas control valve 322 may shut-off the gas control valve 322 from flowing gas to the gas flame burner 350 and, upon the temperature sensor 332 sensing the actual temperature moving back below the desired temperature, then the stepper portion 326 of the gas control valve 322 may open the gas control valve 322 to flow gas through the gas flame burner 350, which may then ignite to further heat the cooking chamber 318 toward the desired temperature. In this manner, the controller 334 and the stepper portion 326 of the gas control valve 322 may be employed for a user to maintain a desired temperature in the cooking chamber 318 of the air fryer 300. The functions of any portion of the gas control valve 322, the one or more sensors 328, and the controller 334 of this embodiment may be implemented in the previously described embodiments, set forth herein.

The various structural components of the various embodiments of an air fryer set forth herein may be formed from metallic materials, such as stainless steel, steel, aluminum, copper, or any other suitable metallic material, as well as some components may be formed from one or more polymeric materials or any other materials needed to form and manufacture the various components of the air fryer, as known by one of ordinary skill in the art. Further, the structural components of the air fryer may be formed by employing known manufacturing techniques and processes, such as welding, molding, milling, drilling, bending, fastening, soldering, etc., as known to one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A portable outdoor air fryer, the portable outdoor air fryer comprising:
a main body including a first wall, a second wall, and a third wall, the first wall extending to define a cooking chamber, the second wall extending along the first wall to define a first gap therebetween, the third wall extending along the second wall to define a second gap therebetween, the first gap and the second gap sized and configured to provide air flow into and out of the main body, the main body including a heating element positioned below the cooking chamber and configured to provide heat within the first gap for heating the first wall to heat the cooking chamber;
a basket container including a container wall and a handle, the perforated container positionable within the cooking chamber and removable from the cooking chamber such that, upon the basket container being positioned within the cooking chamber, the container wall is configured to be positioned over a chamber opening defined in the main body; and
a primary fan positioned directly adjacent the cooking chamber so that the fan is configured to mix air within the cooking chamber.

2. The portable outdoor air fryer of claim 1, wherein the second wall and third wall extend to define vents positioned adjacent to each other, the vents sized and configured to direct air from the first gap and the second gap to an exterior of the main body.

3. The portable outdoor air fryer of claim 1, wherein the main body extends to define an upper chamber with an upper fan positioned at least partially within the upper chamber, the upper chamber positioned above the cooking chamber such that the primary fan is positioned at least partially within the upper chamber, the upper fan configured to blow air over a motor of the primary fan.

4. The portable outdoor air fryer of claim 1, wherein the second gap is configured to cool an exterior of the main body such that the second gap draws air from a lower side of the main body and exits the main body along an upper portion of the main body.

5. The portable outdoor air fryer of claim 1, wherein the heating element is positioned below burner vents defined in the first wall, the burner vents sized and configured to facilitate heat into the first gap to heat the cooking chamber.

6. The portable outdoor air fryer of claim 1, wherein the primary fan is enclosed inside a fan housing, the fan housing positioned over a hole defined in the first wall extending to define the cooking chamber.

7. The portable outdoor air fryer of claim 1, wherein the heating element comprises a gas burner, the gas burner coupled to a gas control valve having a solenoid portion and a stepper portion.

8. A portable outdoor air fryer, the portable outdoor air fryer comprising:
a main body extending to define chamber walls, an inner shield, and an outer shield, the chamber walls extending to define a cooking chamber, the inner shield extending along the chamber wall to define a first gap, the outer shield extending along the inner shield to define a second gap, the first gap and the second gap sized and configured to provide air flow into and out of an interior of the main body, at least one of the first gap and the second gap including a heating element positioned therein;
a basket container including a container wall and a handle, the basket container positionable within the cooking chamber and removable from the cooking chamber such that, upon the basket container being positioned within the cooking chamber, the container wall is configured to be positioned over a chamber opening defined in the main body; and
a primary fan positioned directly adjacent the cooking chamber so that the fan is configured to mix air within the cooking chamber.

9. The portable outdoor air fryer of claim 8, wherein the inner shield and outer shield extend to define vents therein and positioned adjacent to each other along an upper portion of the main body, and wherein, the vents are sized and configured to direct air from the first gap and the second gap to an exterior of the main body.

10. The portable outdoor air fryer of claim 8, wherein the main body extends to define an upper chamber with a second fan positioned at least partially within the upper chamber, the upper chamber positioned above the cooking chamber such that the primary fan is positioned at least partially within the upper chamber, the second fan configured to blow air over a motor of the primary fan.

11. The portable outdoor air fryer of claim 8, wherein the second gap is configured to cool an exterior of the main body such that the second gap draws air from a lower side of the main body and exits the main body along an upper portion of the main body.

12. The portable outdoor air fryer of claim 8, wherein the heating element is positioned below burner vents defined in the inner shield, and wherein the burner vents are sized and configured to direct heat into the first gap to heat the cooking chamber.

13. The portable outdoor air fryer of claim 8, wherein the primary fan is enclosed inside a fan housing, the fan housing positioned over a hole defined in the first wall extending to define the cooking chamber.

14. The portable outdoor air fryer of claim 8, wherein the heating element comprises a gas burner, the gas burner coupled to a gas control valve having a solenoid portion and a stepper portion.

15. A method for cooking food in a portable outdoor air fryer, the method comprising:
providing a main body including a first wall, a second wall, and a third wall, the first wall extending to define a cooking chamber, the second wall extending along the first wall to define a first gap therebetween, the third wall extending along the second wall to define a second gap therebetween, the first gap and the second gap sized and configured to provide air flow into and out of the main body, the main body including a heating element positioned below the cooking chamber to heat the cooking chamber;
positioning a basket container containing a food product into the cooking chamber, the basket container including a container wall and a handle, the basket container being positionable and removable within the cooking chamber such that, upon the basket container being positioned within the cooking chamber, the container wall closes-off a chamber opening defined in the main body;
heating the cooking chamber by activating the heating element to produce heat within the cooking chamber; and
mixing heated air within the cooking chamber with a fan positioned directly adjacent the cooking chamber.

16. The method according to claim 15, wherein the heating comprises positioning the heating element below the cooking chamber to heat the first wall and to heat the cooking chamber.

17. The method according to claim 15, wherein the heating comprises flowing heated air in the first gap to heat the first wall to heat the cooking chamber such that the heated air flows upward along the first gap and through inner vents extending from the first gap to the second gap and then through outer vents extending from the second gap to an exterior of the main body.

18. The method according to claim 15, further comprising drawing air from an exterior lower side of the main body into the second gap so that air flows upward along the second gap to the outer vents to flow to the exterior of the main body.
